(19) United States
(12) Patent Application Publication
(10) Pub. No.: US 2003/0027573 A1
(43) Pub. Date: Feb. 6, 2003

(54) Masked identification code registration system and masked registration method

(75) Inventors: Ming-Long Chien, Taipei (TW); Ming-Che Lee, Tainan Hsien (TW); Chih-Yang Tai, Pingtung City (TW); Ming-Che Ho, Taipei (TW); Kwan-Chiun Lin, Taipei (TW)

Correspondence Address: BACON & THOMAS, 4th Floor, 625 Slaters Lane, Alexandria, VA, 22314, US

(73) Assignee: SKYSOFT Co.,Ltd., Taipei (TW)

(21) Appl. No.: 10/207,858

(22) Filed: Jul. 31, 2002

(30) Foreign Application Priority Data
Aug. 2, 2001 (TW) 90118941

(51) Int. Cl. H04M 3/42; H04Q 7/20

(52) U.S. Cl. 455/433; 455/414; 455/435

(57) ABSTRACT

A masked identification code registration system is designed to allow a user to gain an access to a content provider via a telecommunication system. The masked identification code registration system a telecommunication user database, a registration system, and a masked identification code generator by which an identification code of the telecommunication user database 8 is converted into a masked identification code, so as to enable the user to attain a masked registration in the content provider.

### FIELD OF THE INVENTION

The present invention relates generally to the information technology, and more particularly to a masked identification code registration system and a masked registration method.

### BACKGROUND OF THE INVENTION

The registration system, which is commonly used by the content providers of the internet, is a common registration system (CRS) by which the content providers are provided by the telecommunication system with an anonymous identification code (AID) instead of a real identification code (RID). This is due to the confidentiality regulation of the telecommunication system which prohibits the data disclosure of a telecommunication user. As a result of this regulatory hurdle, it is conceivably inconvenient to the operators of the internet content providers, as well as the operators of the registration system.

### SUMMARY OF THE INVENTION

It is therefore the primary objective of the present invention to provide an internet registration system with a masked identification code (MID) in place of the anonymous identification code (AID) without breach of regulation which prohibits an unauthorized disclosure of data of telecommunication clients.

It is another objective of the present invention to provide a masked identification code registration system.

It is still another objective of the present invention to provided a masked identification code registration system having a masked identification code generator.

It is still another objective of the present invention to provide a masked registration method.

The masked identification code registration system of the present invention enables its user to carry out a masked registration with the internet content provider via a telecommunication system. The MID registration system of the present invention comprises a telecommunication user database, a registration system, and a masked identification code generator by which the identification code of the telecommunication user database is converted into a masked identification code. The internet content provider is then provided with the masked identification code instead of the anonymous identification code. In other words, the system of the present invention enables its users to attain a masked registration.

The telecommunication user database referred to above is the user database of an ordinary telecommunication system, or similar database. Such user database contains alias and nickname of the telecommunication system user.

The registration system referred to above is a common registration system, such as the conventional internet registration system.

The masked identification code generator of the present invention is any software or hardware capable of generating the masked identification code (MID). The MID generator of the present invention may be a combination of the software and the hardware. For example, the MID is automatically generated from the real identification code (RID) in accordance with a specific mode. The MID comparative code of a specific RID may be found in the prestored RID/MID comparative code database. However, the hybrid method is preferred.

The telecommunication user database and the MID generator are preferably integral parts of the telecommunication system. However, they may be set up independently provided that they are permitted by law.

Each user is allowed to have one or more MIDs of his or her own choice. If the user chooses to give up his or her privilege to designate the MID, the telecommunication system may designate the MID on behalf of the user.

If the telecommunication system and the registration system are operated by the same owner, an MID policy, a RID policy, or an MID-RID hybrid policy may be implemented. If the telecommunication system and the registration system are operated by the different owners, the MID policy is mandatory. If law permits, the RID or the RID-MID hybrid policy may be then implemented.

The purpose of converting the identification code of the user database into the MID is to verify that the user is a telecommunication system user. The MID generator generates the MID prior to the user's entry into an internet content provider. The MID so generated is transmitted to the internet content provider.

### BRIEF DESCRIPTION OF THE DRAWINGS

FIG. 1 shows a block diagram of the conventional registration system in conjunction with the telecommunication system.

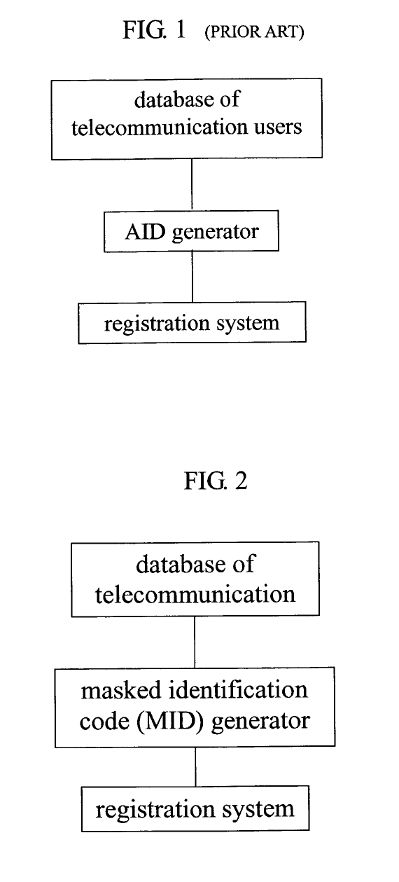

FIG. 2 shows a block diagram of the masked registration system of the present invention in conjunction with the telecommunication system.

FIG. 3 shows an operational flow diagram of a user of the present invention, a system operator, and an internet content provider.

FIG. 4 show a flow diagram of a first preferred embodiment of the present invention.

FIG. 5 shows a flow diagram of a second preferred embodiment of the present invention.

FIG. 6 shows a flow diagram of a third preferred embodiment of the present invention.

FIG. 7 and 8 are flow diagrams of the present invention in conjunction with the internet content provider.

FIG. 9 and 10 are data-providing flow diagrams of the present invention.

### DETAILED DESCRIPTION OF PREFERRED EMBODIMENTS

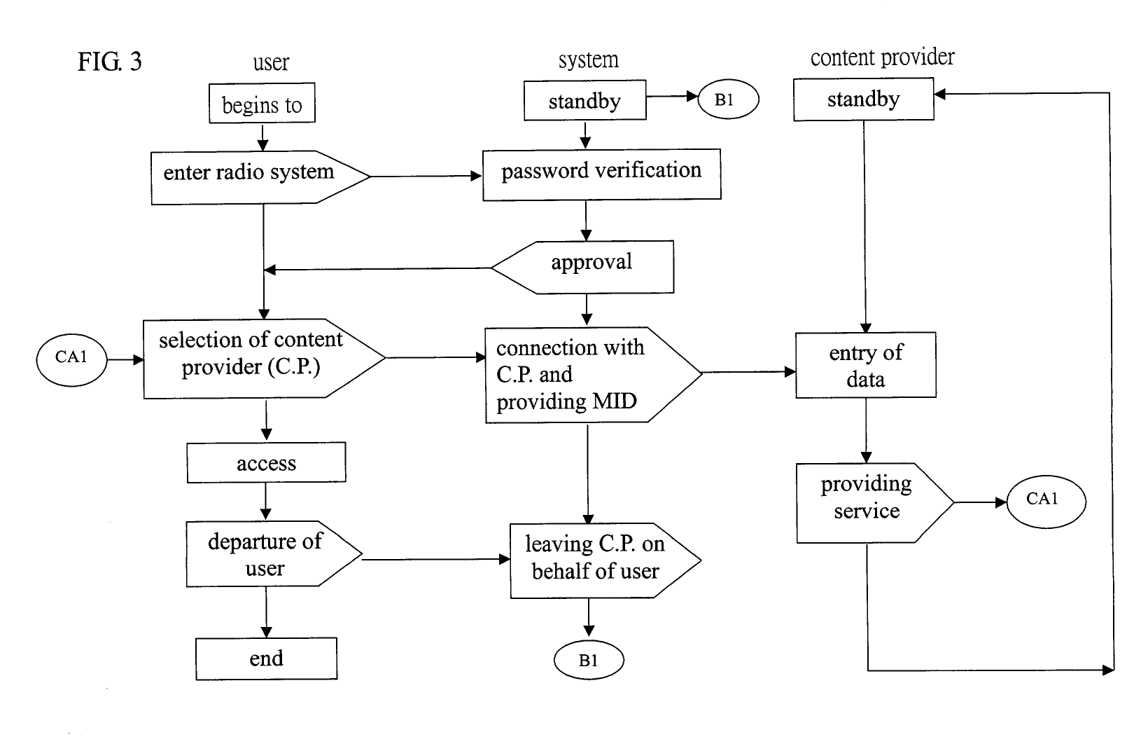

As illustrated in FIG. 2, the masked registration system of the present invention works in conjunction with a telecommunication system such that an internet content provider is furnished with a masked identification code (MID) by the telecommunication system.

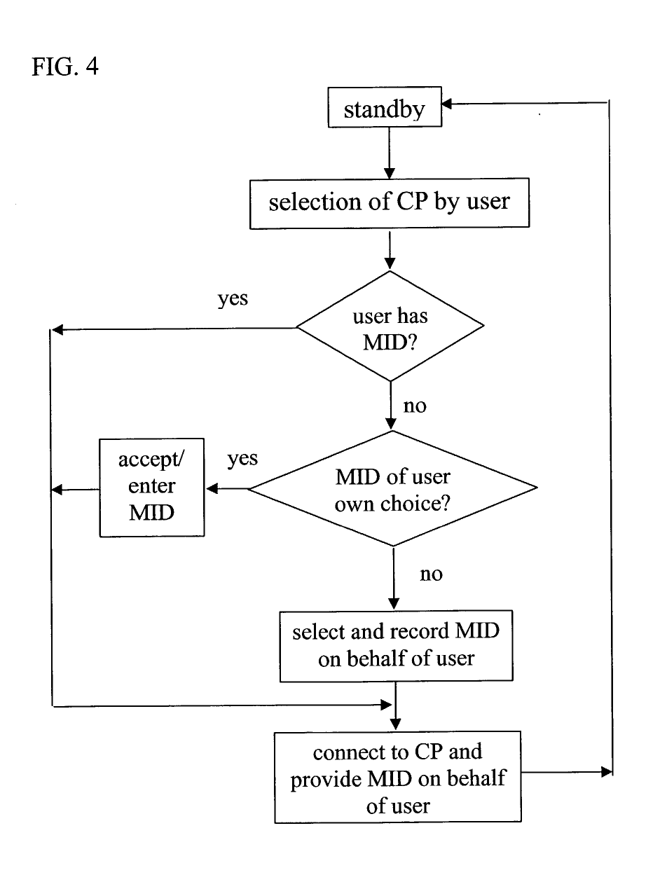

As shown in FIG. 3, when a user begins using the system of the present invention by gaining an access to a radio system. Upon completion of the password verification, an approval signal is transmitted by the system operator, thereby enabling the user to select an internet content provider. Thereafter, the user is connected to the internet content provider by the system operator on behalf of the user such that the internet content provider is furnished by the system operator with the user's MID which is generated by a masked identification code generator (not shown in the drawing). Upon completion of providing the user's MID to the content provider, the system operation remains on standby. When the entry of data by the user is completed, the transaction is closed. The content provider is once again on standby.

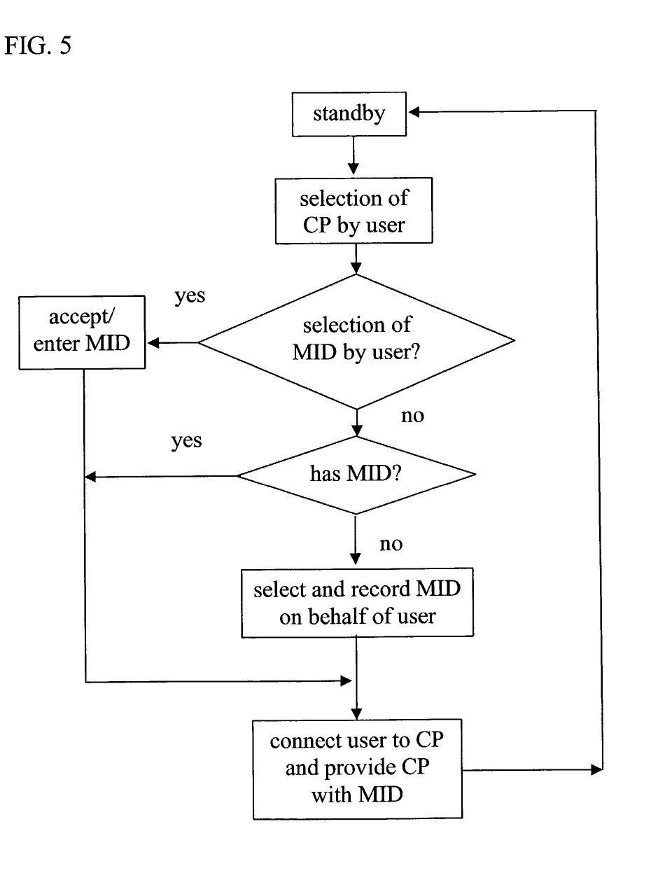

The operational flow of the system operator is explicitly described hereinafter with reference to FIGS. 4-6, in which the verification of RID by the system operator is omitted. As the user has selected a content provider, the masked identification code generator begins looking for an MID comparative to a RID which is kept in the telecommunication system user database. If a comparative MID is found, the user is automatically connected to the content provider. In the meantime, the content provider is provided with the user's MID by the system operator. If no comparative MID is found, such fact is displayed to alert the user to select an MID of his or her own choice. The selected MID is then recorded in the telecommunication user database. In the meantime, the user is connected to the content provider. The selected MID is also transmitted to the content provider. In the event that the user does not wish to select an MID, the system operator selects the MID on behalf of the unwilling user. The selected MID is recorded in the telecommunication user database and is transmitted to the content provider. Such a service mode as described above is relatively adapted to a situation in which a user with only one MID is involved.

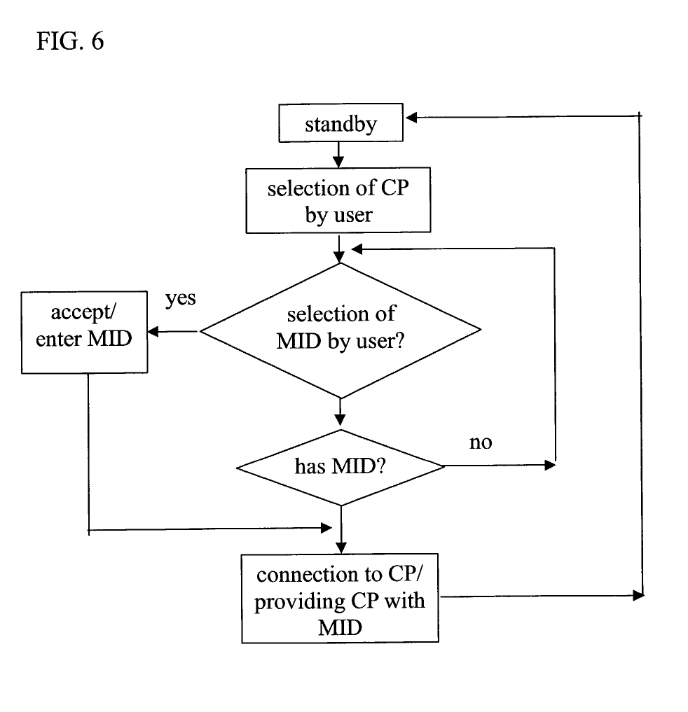

As shown in FIG. 5, if a user selects an MID at the time when the user picks a content provider, the MID is then recorded in the telecommunication user database to serve as an identification code of the user in relation to the content provider. A user may select various MIDs in relation to different content providers. Each time when the MID is recorded in the telecommunication user database, the MID which was already recorded in the database in a previous occasion, the MID is renewed. The user may use the MID which is already recorded in the database. If the user does not select the MID and does not have an identification code relative to the content provider, the MID generator generates an MID, which may or may not be recorded in the database depending on the user's desire. This process flow is better adapted to a situation in which a plurality of MIDs are compared with one RID. However, this process flow may be applied to a one-to-one mode in which a new RID-MID description is provided.

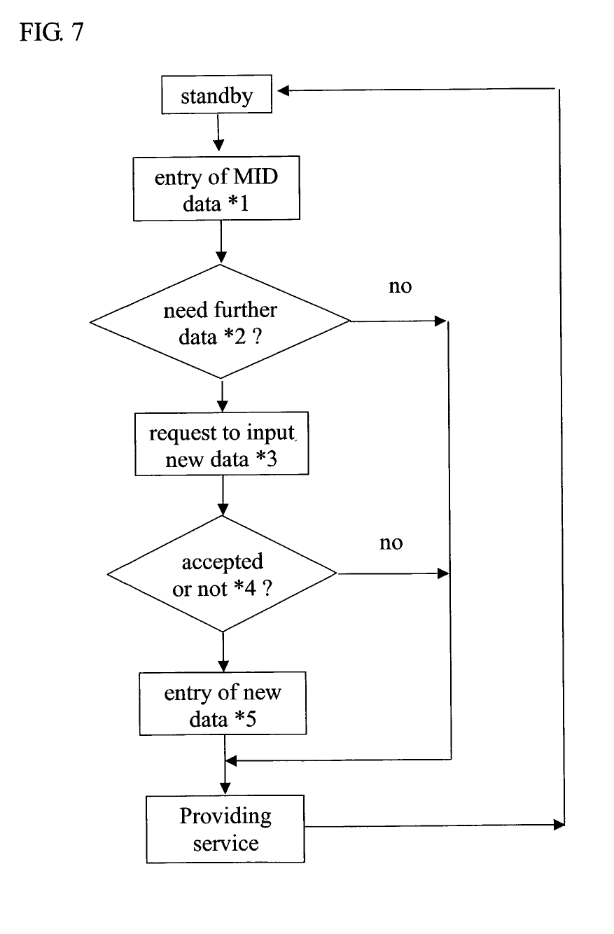

As shown in FIG. 6, the masked identification code generator does not generate the MID. In the event that the MID is not found, the selection mode of MID by the user is adapted. If the user refuses to select, the process is repeated in the loop to force the user to make a selection or to drop out of the system.

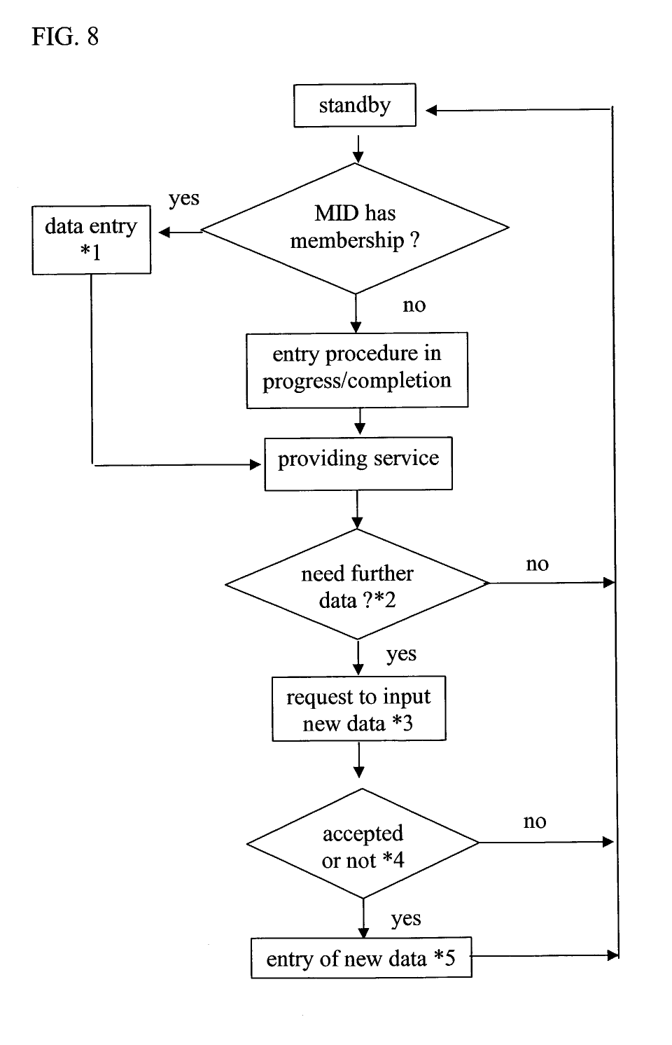

As shown in FIG. 7, the process flow is adapted to a situation in which the service is provided by the content provider on a non-membership basis. The data *1 refer to MID, service date, time, description, etc. The so-called new data *2, *3, *4, such as user's age, academic background, hobby, address, website, etc. *5 so-called new data entry is derived from the original data of the system operator upon authorization of the user, or from the on-line input of data. *2, *3, *4, *5, refer to the procedures after service.

As shown in FIG. 8, the process flow is adapted to a situation in which the service is provided by the content provider on a membership basis. *1, *2, *3, *4, *5 are similar in definition as those of FIG. 7. These procedures are done after the service.

If the membership is checked by the system operator, RID or MID is used. If the user is a member, the user is connected to the content provider. If the user is not a member, the user is also connected to the content provider. Thereafter, the procedures of membership entry, service, etc. are done by the content provider. The membership verification procedure is done by the content provider.

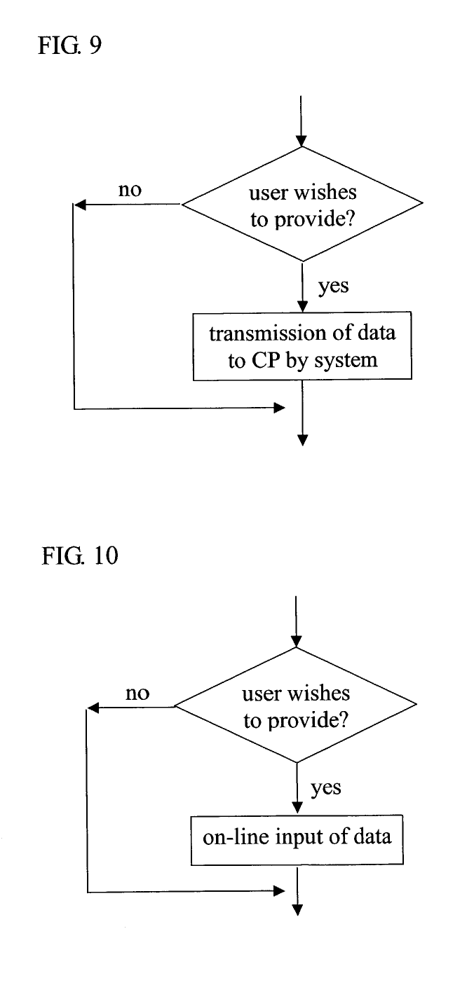

As shown in FIGS. 9 and 10, additional data are provided such that the data of the telecommunication system operator are provided to is the content provider, as shown in FIG. 9, and that the additional data are provided by the user by the on-line input of data, as shown in FIG. 10. A combination of both methods may be used. The input of additional data may be prohibited.

The data of the user may be directly provided by the system, such as the user's mobile phone number, website, etc., upon authorization of the user. Such authorization must be clearly stated in the agreement between the user and the content provider.

In light of the masked identification code registration system of the present invention, the personal data of a user are duly protected. In addition, the masked identification code registration system simplifies the operating flow between the content provider and the system operator. For example, the verification and the input of additional data are simplified.

The present invention also provides a masked registration method, which is described hereinafter.

When a user wishes to enter a content provider via a telecommunication system, the system operator makes use of a masked identification code generator to generate a masked identification code in conjunction with the telecommunication user database of the telecommunication system. In the meantime, the user is connected to the content provider, with the masked identification code being transmitted to the content provider to serve as the user's identification code. The telecommunication system and the system operator may be the same corporation or different corporations, preferably the former.

The mode of forming MID, the relationship between MID and RID, the RID verification, and the membership verification are the same as those which are described with reference to FIGS. 2-10. `

What is claimed is:

1. A masked identification code registration system enabling a user to gain a masked registration at a content provider via a telecommunication system, said masked identification code registration system comprising:
a telecommunication user database;
a registration system; and
a masked identification code generator;
wherein said masked identification code generator is used to convert an identification code of said telecommunication user database into a masked identification code whereby said masked identification code is transmitted to the content provider.

2. The masked identification code registration system as defined in claim 1, wherein said masked identification code is ordered by the system on behalf of the user, thereby allowing each user to have only one masked identification code.

3. The masked identification code registration system as defined in claim 1, wherein said masked identification code is ordered by the user.

4. The masked identification code registration system as defined in claim 1, wherein said masked identification code is ordered by the system on behalf of the user in the event that the user fails to order said masked identification code.

5. The masked identification code registration system as defined in claim 1, wherein various masked identification codes are selected by the user in relation to different content providers.

6. The masked identification code registration system as defined in claim 1, wherein the system operator is allowed to transmit additional data of the user from the telecommunication user data base to the content provider upon being authorized to do so by the user.

7. The masked identification code registration system as defined in claim 6, wherein the system operator is allowed to transmit additional data of the user from the telecommunication user database to the content provider upon being authorized to do so by the user.

8. The masked identification code registration system as defined in claim 1, wherein said masked identification code generator and said registration system form a unified masked registration system.

9. The masked identification code registration system as defined in claim 6, wherein said masked identification code generator and said registration system form a unified masked registration system.

10. The masked identification code registration system as defined in claim 7, wherein said masked identification code generator and said registration system form a unified masked registration system.

11. A masked registration method comprising the following steps of:
(a) generating a masked identification code by a masked identification code generator of the telecommunication system operator in conjunction with a telecommunication user database of the telecommunication system, when a user is trying to gain an access by to a content provider via a telecommunication system;
(b) connecting the user to the content provider by the telecommunication system operator; and
(c) providing the content provider with the masked identification code of the user by the telecommunication system operator.

12. The method as defined in claim 11, wherein the masked identification code is selected by the system on behalf of the user such that the user has only one masked identification code.

13. The method as defined in claim 11, wherein the masked identification code is selected by the user.

14. The method as defined in claim 11, wherein the masked identification code is selected by the system in the event that the user does not wish to make a selection.

15. The method as defined in claim 11, wherein the user is provided with various masked identification code relative to various content providers.

16. The method as defined in claim 11, wherein the telecommunication user database contains additional data in connection with the user whereby the additional data are transmitted to the content provider by the system operator who is authorized to do so by the user.

17. The method as defined in claim 16, wherein the telecommunication user database contains additional data in connection with the user whereby the additional data are transmitted to the content provider by the system operator who is authorized to do so by the user.

18. The method as defined in claim 11, wherein the masked identification code generator and the registration system form a unified masked registration system.

19. The method as defined in claim 16, wherein the masked identification code generator and the registration system form a unified masked registration system.

20. The method as defined in claim 17, wherein the masked identification code generator and the registration system form a unified masked registration system.
